(19) United States
(12) Patent Application Publication
(10) Pub. No.: US 2025/0038223 A1
(43) Pub. Date: Jan. 30, 2025

(54) SEPARATOR PLATE FOR AN ELECTROCHEMICAL SYSTEM, METHOD FOR THE PRODUCTION OF SUCH A SEPARATOR PLATE AND CORRESPONDING ELECTROCHEMICAL SYSTEM COMPRISING SUCH A SEPARATOR PLATE

(71) Applicant: Reinz-Dichtungs-GmbH, Neu-Ulm (DE)

(72) Inventors: Christian LUKSCH, Altenstadt (DE); Ahmet ORUC, Neu-Ulm (DE); Felix SENF, Neu-Ulm (DE); André SPEIDEL, Bussmannshausen (DE)

(21) Appl. No.: 18/785,896

(22) Filed: Jul. 26, 2024

(30) Foreign Application Priority Data
Jul. 28, 2023 (DE) 20 2023 104 275.9

(51) Int. Cl. H01M 8/0258; H01M 8/1004

(52) U.S. Cl. CPC H01M 8/0258; H01M 8/1004

(57) ABSTRACT

The present disclosure relates to a separator plate for an electrochemical system, comprising first and second individual plates connected by means of a welded joint, each individual plate comprising at least one through-opening for passage of a fluid, a flow field, a distribution or collecting region which fluidically connects the through-opening to the flow field, and a transition region which is arranged between the flow field and the distribution or collecting region, wherein the welded joint is arranged in the flow field and/or in the transition region, wherein the welded joint extends longitudinally from a first end located in a first end region to a second end located in a second end region, wherein the welded joint forms an end crater between the first and second ends and the end crater is spaced from the first and second ends.

### CROSS REFERENCE TO RELATED APPLICATION

The present application claims priority to German Utility Model Application No. 20 2023 104 275.9, entitled “SEPARATOR PLATE FOR AN ELECTROCHEMICAL SYSTEM, AND CORRESPONDING ELECTROCHEMICAL SYSTEM COMPRISING SUCH A SEPARATOR PLATE”, filed Jul. 28, 2023. The entire contents of the above-identified application is hereby incorporated by reference for all purposes.

### TECHNICAL FIELD

The present disclosure relates to a separator plate for an electrochemical system, a method for the production of such a separator plate and to an electrochemical system comprising such a separator plate.

### BACKGROUND AND SUMMARY

Known electrochemical systems, for example fuel cell systems or electrochemical compressor systems, redox flow batteries and electrolyzers, usually comprise a plurality of separator plates which are arranged in a stack, such that in each case two adjacent separator plates enclose an electrochemical cell. The separator plates usually each comprise two individual plates which are connected to one another along their rear sides facing away from the electrochemical cells. The separator plates can be used, for example, for electrically contacting the electrodes of the individual electrochemical cells (e.g. fuel cells) and/or for electrically connecting adjacent cells (series connection of the cells). In the case of fuel cells, bipolar plates are often used as separator plates.

The individual plates of the separator plates may comprise channel structures for supplying the cells with one or more media and/or for transporting media away from the cells. The media may for example be fuels (e.g. hydrogen or methanol), reaction gases (e.g. air or oxygen) or a coolant as fed media and reaction products and heated coolant as discharged media. Furthermore, the separator plates may serve for transferring the waste heat produced in the electrochemical cell, as is produced for instance during the conversion of electrical or chemical energy in a fuel cell, and may be configured to seal off the various media channels or cooling channels from one another and/or from the outside. In the case of fuel cells, the reaction media, e.g. fuel and reaction gases, are normally conducted on the mutually averted surfaces of the individual plates, while the coolant is conducted between the individual plates. The electrochemical cells in particular of a fuel cell may for example each comprise a membrane electrode assembly (or MEA) with a respective polymer electrolyte membrane (PEM) and electrodes. The MEA may also comprise one or more gas diffusion layers (GDL) which are normally oriented towards the separator plates, such as towards bipolar plates of fuel cell systems, and are for example in the form of a carbon felt.

The structure and function of the individual plates often require that the channels of the individual plates of the same separator plate run parallel to each other in some regions and/or cross each other in at least some regions. The rear sides of the channel bases can be brought into contact and connected in regions running parallel to each other and/or in the intersection regions. The connection of the two individual plates ensures that the spaces between the individual plates, as well as the spaces between an individual plate and the adjacent component on the opposite side, retain their volume during operation and are not or not significantly deformed by operating pressures and/or other forces. Narrow channel widths and/or intersecting channels therefore place high demands on the accuracy of the positioning of the individual plates relative to each other and on the positioning of the instrument intended for forming the connection relative to the individual plates. Conventional methods for connecting the individual plates to one another are, for example, welding, laser welding, soldering or adhesive bonding. If the required accuracy of the positioning is not observed when connecting the individual plates, the offset causes the connections to be too weak or to be entirely absent at least in part. The pressure of the coolant conducted between the individual plates may then result in tearing of the connections, these tearing open for example between the plates or for example a weld plug being torn from one or both individual plates, such that a hole is produced at least in one plate. If the joint is designed as a welded joint, the rapid cooling of the weld pool typically results in a so-called end crater at the end of a weld seam. Especially in the region of the end crater, star-shaped cracks can occur, which can lead to immediate leakage or reduced durability. Additionally or alternatively, the offset can lead to too much energy being introduced into one point of an individual plate and burning through it, also creating a hole. The individual plates may thus be damaged along the connecting locations to the point of becoming unusable. This can result in the electrochemical cells enclosed between adjacent separator plates being flooded with a cooling fluid that is conducted between the individual plates and passes through the cracks in the individual plates. A direct uncontrolled reaction between the reaction media may also occur if both individual plates comprise holes. Both can result in failure of the entire stack. The methods used to date for joining the individual plates in regions can therefore result in a high level of waste in production or a short service life of the system in operation.

The present disclosure is thus based on the object of providing a separator plate for an electrochemical system, said separator plate being as stable as possible and being able to be produced with the lowest possible number of rejects.

This object is achieved by means of a separator plate for an electrochemical system, a method for the production of such a separator plate and an electrochemical system according to the present disclosure.

Correspondingly, a separator plate for an electrochemical system is proposed. The separator plate for an electrochemical system comprises a first individual plate and a second individual plate connected to the first individual plate by means of a welded joint.

Each individual plate comprises at least one through-opening for the passage of a fluid, a flow field, and a transition region, which is arranged between the flow field and the through-opening and fluidically connects the through-opening to the flow field.

The welded joint is located in the flow field and/or in the transition region.

Furthermore, both individual plates can have a distribution or collection region, which fluidically connects the through-opening with the flow field and is thus arranged between the through-opening and the flow field.

The welded joint extends longitudinally from a first end located in a first end region to a second end located in a second end region. The welded joint forms an end crater between the first end and the second end. The end crater is spaced from the first end of the welded joint and from the second end of the welded joint.

In pressure pulsation tests, in which a medium is forced between the individual layers of the separator plate at high and alternating pressure in order to examine the durability of separator plates, it has been shown that a welded joint can develop tears or can even completely tear open in its end regions, that is to say at the start and/or at the end of the welded joint, where the welding tool starts up or shuts down. This tearing open is sometimes also referred to as peeling of the welded joint and often has a negative influence on the service life of the separator plate. The end regions are thus often weak points of the welded joint.

The ends of the welded joint can be subjected to greater stress than regions of the welded joint that lie between the ends of the welded joint, particularly in the case of pulsating compressive stress caused by coolant conducted between the individual plates. The proposed design of the welded joint has the advantage that the region of the end crater, in which the welded joint typically has weaker joint properties, is at a distance from the particularly stressed ends of the welded joint. In this way, cracks and the resulting leaks can be reduced or even prevented.

In one embodiment, the welded joint can be designed in such a way that it does not form an end crater in the first end region and/or in the second end region.

The first end region of the welded joint can be defined as the region extending from the first end of the welded joint in the direction of the second end of the welded joint. The first end region can extend from the first end of the welded joint to immediately adjacent to the end crater. The second end region can be defined as the region that extends from the second end of the welded joint in the direction of the first end of the welded joint. The second end region can extend from the second end of the welded joint to immediately adjacent to the end crater. Alternatively, the end region can be defined by the region of the welded joint where the welding tool or welding laser beam is applied. Accordingly, this end region can be called the approach region of the welding tool or the welding laser beam. As the welding tool approaches, the two individual plates may not be completely welded together locally in the end region compared to the rest of the welded joint, for example.

The welded joint can comprise a first weld seam and a second weld seam that at least partially overlap. The end crater can be arranged in an overlap region. The overlap region can be defined as a region in which the first weld seam at least partially overlaps the second weld seam. For example, a length of the first and/or second end region can correspond to at most twenty times the length of the end crater in the overlap region, optionally at most fifteen times the length of the end crater in the overlap region, optionally at most twelve times the length of the end crater in the overlap region. For example, a length of the first and/or second end region can be at least 100% of the length of the end crater in the overlap region, optionally at least 150% of the length of the end crater in the overlap region, optionally at least 200% of the length of the end crater in the overlap region. The first and/or second end region can have a length that essentially corresponds to the length of the end crater in the overlap region. The length can be measured on the side of the component on which the laser beam enters the component during the production of the welded joint.

In one embodiment, the end crater may be located in the central 85% between, and in particular in the central 70% between, the first and second ends of the welded joint. An arrangement of the end crater in a central region between the first and second ends of the welded joint can have the advantage that the end crater is spaced from the particularly stressed ends of the welded joint.

In one embodiment, the welded joint may have imbricated weld solidification lines in the first direction in the first end region, for example in a region from the first end of the welded joint to the end crater. The welded joint can have imbricated weld solidification lines in the second end region, such as in a region from the second end of the welded joint to the end crater, in a second direction opposite to the first direction.

In one embodiment, the first weld seam may extend from the first end of the welded joint towards the second end of the welded joint, encompassing the end crater and beyond the end crater. The second weld seam can extend from the second end of the welded joint in the direction of the first end of the welded joint, encompassing the end crater, to an end of the end crater facing the first end of the welded joint.

It should be noted that in the present disclosure, the end crater may be defined such that a welding mirror is encompassed by the end crater.

The welded joint can be formed by welding the first weld seam in a first direction, such that an end crater of the first weld seam is formed at the end of the first weld seam. The second weld seam can then be welded in a second direction, in the opposite direction to the first. The second weld seam can at least partially overlap the first weld seam. The end crater of the first weld seam can be traversed by the second weld seam during the production of the welded joint in such a way that the end crater of the second weld seam at least partially overlaps the end crater of the first weld seam or, optionally, lies directly next to the traversed end crater of the first weld seam along the welded joint or lies at a distance next to the traversed end crater of the first weld seam along the welded joint.

The end crater of the second weld seam can form the end crater of the welded joint described above.

In one embodiment, the welded joint can be designed in such a way that the first weld seam overlaps the second weld seam at least in sections in the overlap region. The center lines of the first and second weld seams can be directly above each other or at a distance from each other. For example, a distance between the center line of the first weld seam and the center line of the second weld seam can be at most 25%, at most 20%, or at most 15% of a width of the first and/or second weld seam. The width of the weld seam refers to the actual width of the weld seam, not the width spanned by a curved section of the weld seam.

In one embodiment, the end crater can have a distance to the first end and/or to the second end of the welded joint of at least 20%, or at least 50%, and/or of a maximum of 1000% or a maximum of 800% of the width of the first and/or second weld seam.

The end crater can have a length that corresponds to at least 25% or at least 40%, and/or at most 600%, at most 400%, or at most 250% of the width of the first and/or second weld seam.

The first weld seam can have imbricated weld solidification lines in the first direction, at least in sections, in particular in the first end region, and the second weld seam can have imbricated weld solidification lines in the second direction, at least in sections, in particular in the second end region, with the second direction being opposite to the first direction. In particular, the first weld seam only shows imbricated weld solidification lines in the first direction in regions that are not overlapped by the second weld seam.

The overlap region can have a length that corresponds to at least 400%, at least 500%, or at least 600% of the length of the end crater. The overlap region can have a length that corresponds to at least 10% of the length of the welded joint or at least 20% of the length of the welded joint or at least 30% of the length of the welded joint. The overlap region can have a length that corresponds to a maximum of 80% or a maximum of 60% or a maximum of 50% or a maximum of 40% or a maximum of 35% of the length of the welded joint.

In one embodiment, the welded joint can comprise at least one straight section or have a straight course. For example, the entire welded joint can run in a straight line. Alternatively, a first section of the welded joint can run along a first straight line and a second section of the welded joint can run along a second straight line. The first weld seam can run completely or partially along the first straight line. The second weld seam can run completely or partially along the second straight line. The first straight line can run essentially parallel, optionally exactly parallel, to the second straight line. The first and second straight lines can be offset to the side.

The welded joint may have a first curved portion, wherein the first curved portion extends and is curved such that a virtual straight line extending perpendicularly through the first end region intersects the welded joint at least twice. Alternatively or additionally, the welded joint may have a second curved section, wherein the second curved section extends and is curved in such a way that a virtual second straight line extending vertically through the second end region intersects the welded joint at least twice. The welding geometry can therefore be designed in such a way that a further section of the welded joint, usually the curved section, runs next to the relevant end region, which can stabilize or stiffen the end region of the welded joint.

The welded joint can be a laser welded joint. Laser welded connections can be produced in a particularly precise manner. However, the present document is not limited to laser welded connections.

The welded joint can be designed as a continuous welded joint, e.g. without interruptions. The separator plate, for example a flow field and/or a transition region of the separator plate, can have a large number of such welded joints. In one example, the separator plate has corresponding welded joints at least in the flow field and/or in the transition region; corresponding welded joints can also be provided in the distribution and/or collection regions, but these can differ from the aforementioned welded joints in their detailed design. It is also possible not to provide any welded joints in the distribution or collection region.

In some embodiments, at least one of the end regions and, for example, an associated curved section merge continuously into one another. For example, it may be provided that the first end region adjoins the first curved section or is part of the first curved section and/or that the second end region adjoins a second curved section or is part of the second curved section.

The welded joint can have a shape that is designed in such a way that it can be formed by applying a welding tool and/or welding laser beam at most one time. An end crater of a previously executed weld seam can be traversed by a weld seam executed after the application. This can have the advantage that the welded joint only has one end crater. Alternatively, the welded joint can have a shape that is designed in such a way that it can be formed by repeatedly applying a welding tool and/or welding laser beam.

In one embodiment, the first individual plate in the flow field has structures on a front side facing away from the second individual plate for guiding a reaction medium along the front side of the first individual plate. The second individual plate can have structures on a rear side facing away from the first individual plate for guiding a reaction medium along the rear side of the second individual plate.

These structures for guiding a reaction medium can be provided, for example, by a plurality of webs and channels running between the webs and delimited by the webs. The first individual plates can also each have a distribution and collection region on an outer side of the separator plates. Distribution or collection regions can each comprise structures that are set up to distribute a medium introduced into the distribution region from one of the through-openings via the flow field or to collect or bundle a medium flowing from the active region to a second of the through-openings. A transition region can be arranged between a distribution or collection region and the flow field, through which the channels and webs can continue or in which they can be interrupted. The structures for guiding a reaction medium can be designed as media-conducting embossing structures.

In one embodiment, a plurality of welded joints can be arranged at the bottom of the channels. The bottom of the channels can be defined as the lowest point of the channels. In this region, there is typically a contact surface to the other individual plate (on the back). The weld seam can not only run along this base, but can also extend through the entire thickness of the material, for example in the first individual plate, on the side of the beam entry. In the other, e.g. second individual plate, the weld seam can penetrate a little further than just the surface.

In one embodiment, the channel can be widened in the region of a welded joint. In one embodiment, only the channel of an individual plate can be widened in the region of a welded joint. Alternatively, the channels of the first and second individual plates can each be widened in the region of a welded joint. In some embodiments, the first and second individual plates may have channels of different widths and/or depths. In particular, the cathode plate can have wider and/or deeper gas channels than the anode plate. In particular, in this case the channel of the individual plate can be widened in the region of a welded joint, which has a smaller width. Additionally or alternatively, the channel of the individual plate can be widened in the region of a welded joint where the welding beam enters during welding.

The webs and channels can be rectilinear in the flow field and run parallel to each other, in particular parallel to the main flow direction. In addition or alternatively, the webs and channels in the flow field can be partially or completely wave-shaped, in particular with substantially the same wave shape, in particular running next to each other in phase, and/or periodically repeatingly trapezoidal, in particular running next to each other with substantially the same trapezoidal shape.

The flow field can be characterized, for example, by the fact that all of the webs and channels it comprises are straight and run parallel to each other and parallel to the main flow direction. Alternatively, the webs and channels could also be wave-shaped and, in particular, run next to each other in phase and along the main flow direction with the same wave shape. In addition, the flow field can be characterized by the fact that the webs and channels in the flow field have a constant flow cross-section and/or an essentially constant height. In the transition region, the webs and channels can have a reduced cross-section and/or height compared to the flow field.

In one embodiment, at least one welded joint is arranged in a plurality of channels in the flow field. In general, it is possible that welded joints are arranged in each channel of the flow field. It has however turned out that it is advantageous if at least in sections, orthogonal or transverse—thus under an angle of more than 0° and less than 90°—relative to the main extension direction of a channel, there is a distance between two closest welded joints. For example, there may be at most four channels, optionally at most three channels, in particular at most two channels situated between two closest welded joints. This means that five, in particular four, especially two webs are situated between the closest welded joints.

Additionally or alternatively, a plurality of spaced-apart welded joints can be arranged along a channel. Advantageously, the length of the welding joints and/or the distance between the welding joints closest to each other within one channel at least in areas within one channel is between 0.2 mm and 3 mm, in particular between 0.5 mm and 1.5 mm. It has turned out that with respect to the total peripheral resistance related to the welding joints, a ratio of distance to length is preferred which is smaller than 3, optionally smaller than 2.5.

The welded joints can have an essentially constant distance to the webs delimiting the channel along their extension. A deviation that corresponds approximately to the width of the welded joint can still be considered an essentially constant distance. In this context, one can in particular consider the distance between the welded joints and the center line of the respective immediately adjacent webs in an orthogonal projection onto a plane parallel to the plane of the separator plate.

In particular, the welded joints can be arranged essentially following the main flow direction and transverse to the main flow direction, each essentially in the center of the channel. In order to have sufficient space for the welded joints, the channels may be widened in the respective sections. To this end, the flanks connecting the channel bottoms with the tops of the webs may be steeper than in other sections of the channels without welded joints.

The shape of the welded joints can follow the shape of the channel in which they are arranged.

The present disclosure further relates to a method for producing a separator plate of the type described above. The method comprises the following steps:

Providing a first individual plate and a second individual plate, each individual plate (2a, 2b) comprising at least one through-opening (11a-c) for the passage of a fluid, a flow field (17), and a transition region which is arranged between the flow field (17) and the through-opening (11a-c) and fluidically connects the through-opening (11a-c) and the flow field (17) to one another.

Connection of the two individual plates by means of a welded joint in a contact zone of the individual plates, the welded joint being designed such that the welded joint extends longitudinally from a first end located in a first end region to a second end located in a second end region and the welded joint forms an end crater between the first end and the second end and the end crater is spaced from the first end and from the second end.

The separator plate produced then comprises a first individual plate and a second individual plate connected to the first individual plate, with the two individual plates touching each other in the contact zone.

In the connecting step, a first weld seam can be welded along a first direction. A second weld seam can be welded in the second direction, opposite to the first direction, with the second weld seam overlapping the first weld seam in an overlap region.

An end crater of the first weld seam can be at least partially, optionally completely, traversed by the second weld seam. In this way, a continuous welded joint can be generated that has only one end crater, which is spaced from the first end of the welded joint and from the second end of the welded joint.

In a further aspect, an electrochemical system is proposed which comprises a plurality of stacked separator plates or bipolar plates of the type described above.

In the electrochemical system, a membrane electrode assembly (MEA) comprising a membrane and an edge portion at least partially surrounding the membrane can be arranged between adjacent separator plates of the stack. The edge portion can be used in particular to reinforce the MEA. The flow field of the separator plate can lie within the edge portion, thus it can be framed by the edge portion.

The membrane can have a diaphragm as well as catalyst layers and electrodes. Furthermore, a gas diffusion layer (GDL) may be arranged on one or both surfaces of the MEA, thus between each pair of adjacent separator plates of the plurality of stacked separator plates and the closest MEA. The GDL may extend over the flow field and the transition region of the separator plates.

Exemplary embodiments of the separator plate and of the electrochemical system are illustrated in the figures and will be explained in more detail on the basis of the following description.

### BRIEF DESCRIPTION OF THE FIGURES

FIG. 1 schematically shows a perspective illustration of an electrochemical system comprising a plurality of separator plates or bipolar plates arranged in a stack.

FIG. 2 schematically shows a perspective illustration of two bipolar plates of the system according to FIG. 1 with a membrane electrode assembly (MEA) arranged between the bipolar plates.

FIG. 3 schematically shows a section through a plate stack of a system in the manner of the system according to FIG. 1.

FIG. 4 shows a schematic section of a top view of an exemplary separator plate according to FIGS. 1 to 3, with a series of welded joints arranged in an end region of the flow field adjacent to a transition region.

FIG. 5 shows a schematic section of a top view of a separator plate according to FIG. 4, wherein welded joints are also arranged in two outer channels of the flow field.

FIG. 6 shows a schematic section of a top view of a separator plate according to FIG. 5, wherein welded joints are also arranged in central channels of the flow field.

FIG. 7 shows a schematic section of a top view of a separator plate as shown in FIG. 6, with a row of welded joints arranged in the transition region and additional welded joints arranged in the distribution region.

FIGS. 8A-8C and 8D show various configurations of a welded joint.

FIG. 8C′ schematically shows a height profile along the section B-B indicated in FIG. 8C through the end crater of FIG. 8C.

FIG. 9 shows a section of a top view of a separator plate comprising a welded joint as shown in FIG. 8A looking from a beam entry side.

FIG. 10 shows a section of a top view of a separator plate comprising a welded joint as shown in FIG. 8A, looking from a rear side.

FIG. 11 shows a section of a top view of a separator plate in the region of two welded joints.

FIG. 12 shows a schematic section through the welded joint of the separator plate of FIG. 4 in a region where there is no end crater.

FIG. 13 shows a schematic section through the welded joint of the separator plate of FIG. 4 in a region where an end crater is located.

FIGS. 14A-B schematically show a section of a top view of a flow field of an individual plate with different channel shapes.

FIG. 14C shows the separator plate assembled from the individual plates of FIGS. 14A and 14B with welded joints.

FIG. 15 is a schematic top view of an example separator plate according to FIGS. 1 to 3, with a non-continuous straight welded joint.

FIG. 16 schematically shows a top-view onto a section of an exemplary separator plate with a large number of welded joints.

FIG. 17 schematically shows a method for the production of an exemplary separator plate.

### DETAILED DESCRIPTION

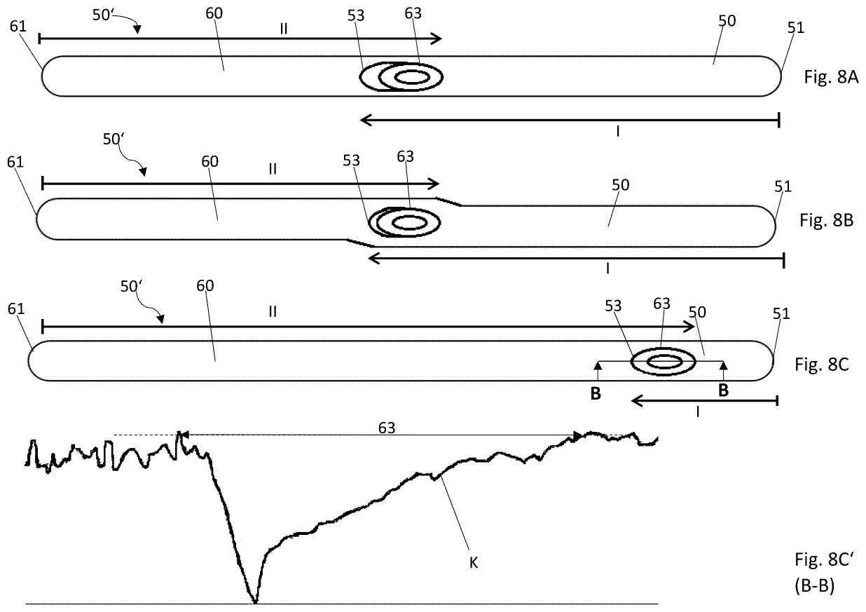

Here and below, features that recur in different figures are denoted in each case by the same or similar reference signs. For the sake of clarity, reference is sometimes made to a complete group of figures (e.g. FIG. 8 instead of one of FIGS. 8A-8D).

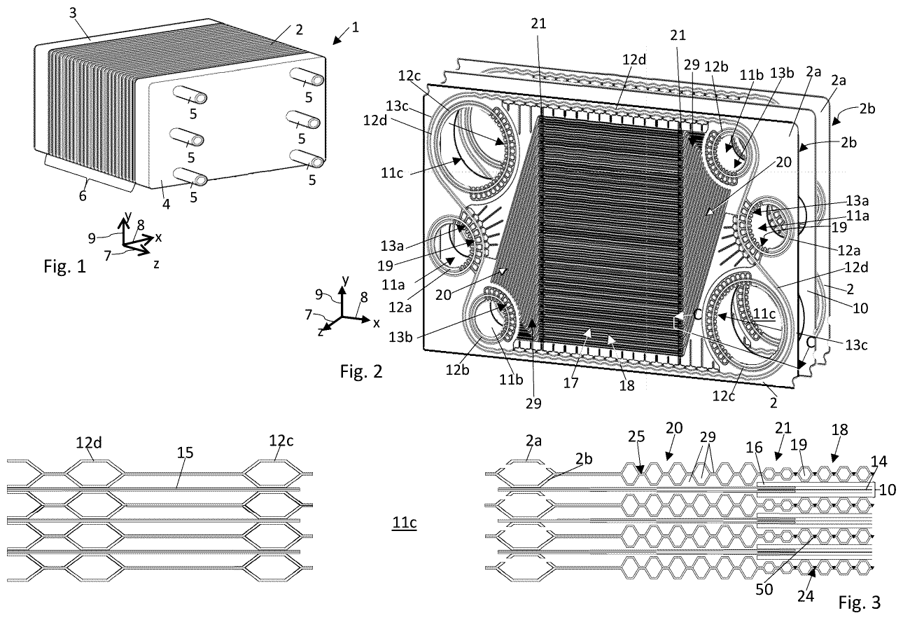

FIG. 1 shows an electrochemical system 1 comprising a plurality of structurally identical metallic separator plates or bipolar plates 2 which are arranged in a stack 6 and are stacked in a z-direction 7. The bipolar plates 2 of the stack 6 are clamped between two end plates 3, 4. The z-direction 7 is also called stacking direction. In the present example, the system 1 is a fuel cell stack. In each case two adjacent bipolar plates 2 of the stack enclose between them an electrochemical cell which serves, for example, for conversion of chemical energy into electrical energy. In order to form the electrochemical cells of the system 1, a respective membrane electrode assembly (MEA) is arranged between adjacent bipolar plates 2 of the stack (see for example FIG. 2). The MEAs typically each contain at least one membrane, e.g. an electrolyte membrane. A gas diffusion layer (GDL) may also be arranged on one or both surfaces of the MEA, not illustrated in FIGS. 1 and 2.

In alternative embodiments, the system 1 may equally be in the form of an electrolyzer, an electrochemical compressor or a redox flow battery. In these electrochemical systems, use may likewise be made of separator plates. The construction of these separator plates may then correspond to the construction of the separator plates 2 which are explained in more detail here, even though the media conducted on or through the separator plates in the case of an electrolyzer, in the case of an electrochemical compressor or in the case of a redox flow battery may differ in each case from the media used for a fuel cell system.

The z-axis 7 together with an x-axis 8 and a y-axis 9 defines a right-handed Cartesian coordinate system. The separator plates 2 each define a plate plane, each of the plate planes of the individual plates being oriented parallel to the x-y plane and thus perpendicular to the stacking direction or to the z-axis 7. The end plate 4 comprises a plurality of media ports 5, via which media can be fed to the system 1 and via which media can be discharged from the system 1. These media which can be fed to the system 1 and which can be discharged from the system 1 may comprise, for example, fuels such as molecular hydrogen or methanol, reaction gases such as air or oxygen, reaction products such as water vapor, or depleted fuels or coolants such as water and/or glycol.

FIG. 2 shows, in perspective form, two adjacent separator plates 2 of an electrochemical system of the type of the system 1 of FIG. 1 and a membrane electrode assembly (MEA) 10 known from the prior art, which is arranged between these adjacent separator plates 2, the MEA 10 being largely concealed in FIG. 2 by the separator plate 2 facing the observer. The separator plate 2 is formed from two individual plates 2a, 2b which are joined together in a materially bonded manner (see for example FIG. 3), of which only the first individual plate 2a which faces the observer and which conceals the second individual plate 2b is visible in FIG. 2. The individual plates 2a, 2b may each be manufactured from a metal sheet, e.g. from a stainless steel sheet. The individual plates 2a, 2b may, for example, be welded to one another, e.g. by laser welded connections.

The individual plates 2a, 2b comprise through-openings which are aligned with one another and which form through-openings 11a-c in the separator plate 2. When a plurality of separator plates of the type of the separator plate 2 are stacked, the through-openings 11a-c form lines which extend in the stacking direction 7 through the stack 6 (see FIG. 1). Typically, each of the lines formed by the through-openings 11a-c is fluidically connected to one of the ports or media ports 5 in the end plate 4 of the system 1. By way of the lines formed by the through-openings 11a, it is possible for e.g. coolant to be introduced into the stack or discharged from the stack. By contrast, the lines formed by the through-openings 11b, 11c may be configured to supply the electrochemical cells of the fuel cell stack 6 of the system 1 with fuel and with reaction gas and to discharge the reaction products from the stack. The media-conducting through-openings 11a-11c are substantially parallel to the plate plane.

In order to seal the through-openings 11a-c in relation to the interior of the stack 6 and in relation to the environment, the first individual plates 2a each comprise sealing arrangements in the form of sealing beads 12a-c which are each arranged around the through-openings 11a-c and which each completely enclose the through-openings 11a-c. The second individual plates 2b comprise, on the rear side of the separator plates 2 which faces away from the observer in FIG. 2, corresponding sealing beads for sealing the through-openings 11a-c (not shown). Alternatively, elastomer seals can also be used.

In an electrochemically active region 18, the first individual plates 2a have a flow field 17 with structures for guiding a reaction medium along the outer side of the individual plate 2a on their outer side facing the viewer of FIG. 2. These structures are provided in FIG. 2 by a plurality of webs and channels which run between the webs and which are delimited by the webs. On the outer side of the separator plates 2 facing the viewer in FIG. 2, the first individual plates 2a also each have a distribution and collection region 20. Distribution or collection regions 20 in each case comprise structures which are configured to distribute a medium introduced proceeding from a first of the two through-openings 11b into the distribution region 20 over the active region 18 or to collect or combine a medium flowing proceeding from the active region 18 towards the second of the through-openings 11b. The fluid-guiding structures 29 of both distribution or collection regions 20 are likewise provided in FIG. 2 by webs and channels which run between the webs and which are delimited by the webs. In the following text, only the distribution region 20 will be discussed for the sake of simplicity; the corresponding statements can equally apply to a collection region 20.

The sealing beads 12a-12c have passages 13a-13c, of which the passages 13a are formed both on the underside of the upper individual plate 2a and on the upper side of the lower individual plate 2b, while the passages 13b are formed in the upper individual plate 2a and the passages 13c in the lower individual plate 2b. For example, the feedthroughs 13a, which are designed as localized elevations of the bead, allow a passage of coolant between the through-opening 12a and the distribution region 20, so that the coolant enters the distribution region between the separator plates or is led out of the collection region 20. Furthermore, the passages 13b enable passage of hydrogen between the through-opening 12b and the distribution region on the top side of the upper individual plate 2a, these passages 13b are characterized by perforations which face the distribution region and which run obliquely with respect to the plate plane. Thus, for example hydrogen flows through the passages 13b from the through-opening 12b to the distribution region on the top side of the upper individual plate 2a or in the opposite direction from the collection region. The passages 13c enable passage of for example air between the through-opening 12c and the distribution region, such that air passes into the distribution region on the bottom side of the lower individual plate 2b or is conducted out of the collection region. The associated perforations are not visible here.

The first individual plates 2a also each comprise a further sealing arrangement in the form of a perimeter bead 12d which runs around the flow field 17 of the active region 18, the distribution and collection regions 20 and the through-openings 11b, 11c and seals them in relation to the through-opening 11a, i.e. in relation to the coolant circuit, and in relation to the environment of the system 1. The second individual plates 2b each comprise corresponding perimeter beads. The structures of the active region 18, the distribution structures of the distribution region and of the collection region 20 and the sealing beads 12a-d are each formed in one part with the individual plates 2a and are each formed into the individual plates 2a, e.g. in an embossing or deep-drawing process or by means of hydroforming. The same applies to the corresponding structures of the second individual plates 2b.

The two through-openings 11b or the lines formed by the through-openings 11b through the plate stack of the system 1 are each fluidically connected to one another via passages 13b in the sealing beads 12b, via the distribution structures of the distribution or collection region 20 and via the flow field 17 in the active region 18 of the first individual plates 2a facing the observer in FIG. 2. Similarly, the two through-openings 11c or the lines formed by the through-openings 11c through the plate stack of the system 1 are each fluidically connected to one another via corresponding bead passages, via corresponding distribution and collection structures and via a corresponding flow field on an outer side of the second individual plates 2b facing away from the observer in FIG. 2. By contrast, the through-openings 11a or the lines formed by the through-openings 11a through the plate stack of the system 1 are each fluidically connected to one another via a cavity 19 enclosed by the individual plates 2a, 2b. This cavity 19 serves in each case for conducting a coolant through the separator plate 2, in particular for cooling the electrochemically active region 18 of the separator plate 2.

FIG. 3 schematically shows a section through a portion of the plate stack 6 of the system 1 from FIG. 1, the section plane being oriented in the z-direction and thus perpendicular to the plate planes of the separator plates 2. In FIG. 3, the sectional plane runs along a bent section, along the sectional line C-C in FIG. 2.

The structurally identical separator plates 2 of the stack each comprise the above-described first metallic individual plate 2a and the above-described second metallic individual plate 2b. Structures for guiding media along the outer surfaces of the separator plates 2, here in particular in each case in the form of webs and channels delimited by the webs, are apparent. In particular, channels on the surfaces of individual plates 2a, 2b which adjoin one another, said surfaces being directed away from one another, and cooling channels in the cavity 19 between individual plates 2a, 2b which adjoin one another are shown. Between the cooling channels both in the distribution or collection region 20 and in the active region 18, the two individual plates 2a, 2b rest on each other in a contact region 24 and are connected to each other there, in the present example by means of laser weld seams 50.

A respective membrane electrode assembly (MEA) 10 known for example from the prior art is arranged between adjacent separator plates 2 of the stack. The MEA 10 typically comprises a membrane, e.g. an electrolyte membrane, and an edge portion 15 connected to the membrane 14. For example, the edge portion 15 can be bonded to the membrane 14, e.g. by an adhesive connection or by lamination. A lowered transition region 21 of the separator plates 2 lies opposite the overlapping region of the edge portion 15 and the membrane 14.

The membrane of the MEA 10 extends in each case at least over the active region 18 of the adjacent separator plates 2 and enables a proton transfer there over or through the membrane 14. However, the membrane does not reach into the distribution or collection region 20. The edge portion 15 of the MEA 10 serves in each case for positioning, fastening and sealing the membrane between the adjoining separator plates 2.

The edge portion 15 in each case covers the distribution or collection region 20 of the adjoining separator plates 2. The edge portion 15 can also extend outwards beyond the perimeter bead 12d and adjoin or protrude beyond the outer edge region of the individual plates 2a, 2b (see FIG. 2).

Furthermore, gas diffusion layers 16 may additionally be arranged in the active region 18. The gas diffusion layers 16 enable direct flow to the membrane over the greatest possible region of the surface of the membrane and can thus improve the transfer of protons via the membrane. The gas diffusion layers 16 may be arranged, for example, in each case on both sides of the membrane in the active region 18 between the adjoining separator plates 2. The gas diffusion layers 16 may be formed, for example, from a fiber felt or comprise a fiber felt.

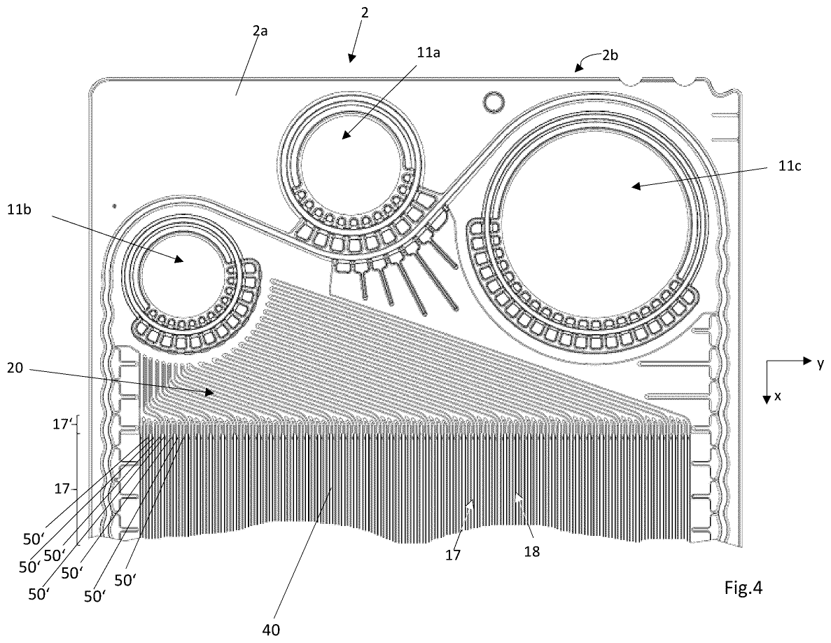

Reference is also made to FIG. 4, which shows a schematic section of a top view of an exemplary separator plate 2 of FIGS. 1 to 3. The separator plate 2 of FIG. 4 has a series of welded joints 50′, which are arranged in an end region of the flow field 17. The end region 17 of the flow field is adjacent to a transition region 17′. The transition region 17′ is located between the collection or distribution region 20 and the flow field 17. For the sake of clarity, only some of the plurality of welded joints 50′ shown are provided with reference numbers as examples.

Pressure pulsation tests carried out by the applicant have shown that a welded joint can form a weak point in the separator plate 2, particularly at its start and end points. When high fluid pressures are applied, a welded joint can sometimes crack at its start and end points.

The present disclosure has therefore been devised in order to further increase the durability of separator plates 2. In particular, the use of a welded joint 50′ is intended to achieve a higher lifespan, at least with regard to excessive operating pressures and/or the operational pulsation of the pressure of the media present, in particular the coolant. As can be seen from FIG. 8A, the welded joint 50′ extends longitudinally according to the present disclosure from a first end 51 located in a first end region to a second end 61 located in a second end region. The welded joint 50 forms an end crater 63 between the first end 51 and the second end 61. The end crater 63 is spaced from the first end 51 of the welded joint 50′ and from the second end 61 of the welded joint 50′.

The welded joint 50′ has a first weld seam 50, a second weld seam 60 and an end crater 63. The first weld seam 50 was welded in a first direction starting at the first end 51 in the direction of the second end 61. The second weld seam 60 was welded in a second direction starting at the second end 61 in the direction of the first end 51. The length of the first weld seam 50, measured from the first end 51 in the direction of the second end, extends beyond the end crater 63, but not as far as the second end 61. The second weld seam 60 begins at the second end and extends around the end crater 63 to the end of the end crater 63 that is closer to the first end 51. The end crater 63 of the welded joint 50′ is the end crater that was formed by stoppage at the end of the second weld seam 60 during welding of the second weld seam 60. An end crater of the first weld seam 50 was traversed by the second weld seam 60 and is therefore not visible in FIG. 4 or FIG. 8A. In the examples shown in FIGS. 4 to 7, the first weld seam 50 and the second weld seam 60 run along a straight line. In other examples, the first weld seam 50 and/or the second weld seam 60 may comprise curved portions.

In addition to the welded joints 50′, the separator plate 2 can have further weld seams that connect the first individual plate 2a to the second individual plate 2b. In contrast to the welded joints 50′, the other weld seams can comprise only one weld seam. An end crater of these weld seams can be present in an end region of the weld seam, for example.

In particular, the welded joints 50′ can be arranged in a region of the respective individual plate that is spanned by gas diffusion layers 16, i.e. in the flow field 17 or in the transition region 21.

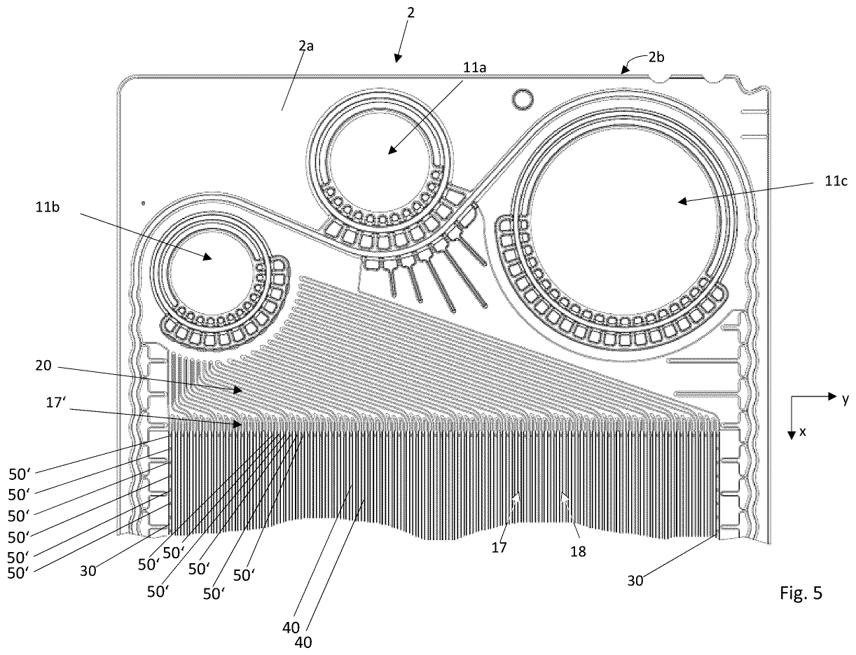

FIG. 5 schematically illustrates a section of a top view of an alternative separator plate. The separator plate 2 of FIG. 5 corresponds to that of FIG. 4, with additional welded joints 50′ arranged in two outer channels of the flow field. The outer channels of the separator plate 2 are in this case the two lateral, outer channels of the flow field, which have the smallest distance to the respective lateral outer edge of the separator plate 2. In this example, the outermost channels run parallel to the outer edge of the separator plate 2. In other examples, the outer channels may have a different shape. A plurality of welded joints 50′ are arranged along these channels in the main flow direction and spaced apart from one another. Instead of some or all of these welded joints 50′, weld seams can be arranged along and in the outer channels, which are formed from only one weld seam.

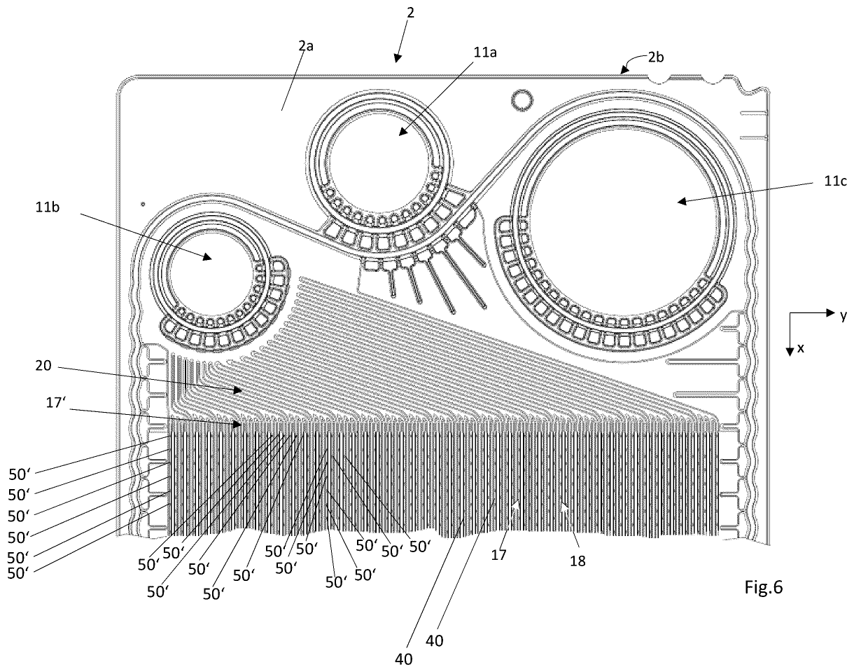

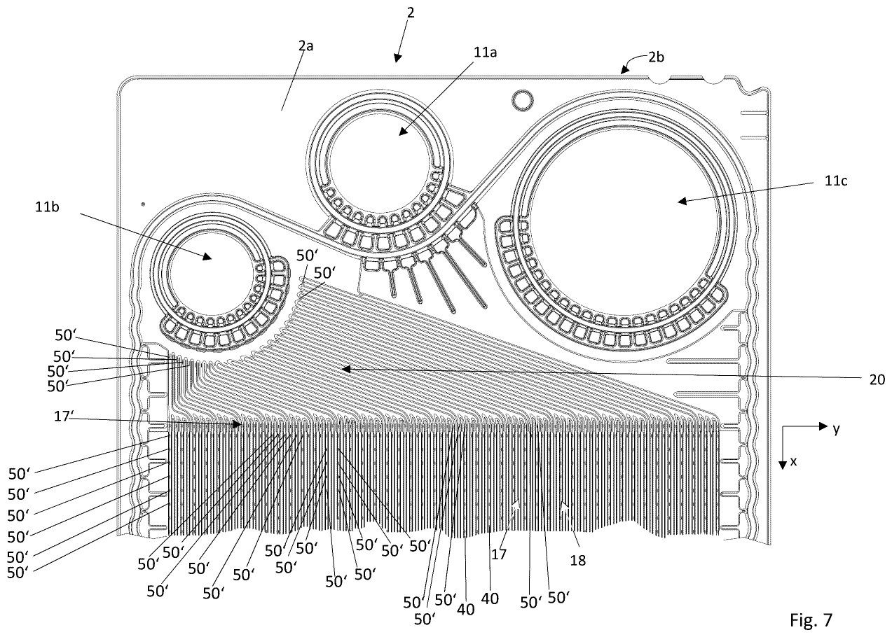

FIG. 6 shows a schematic section of a top view of a separator plate 2 as shown in FIG. 5, with additional welded joints 50′ arranged in channels located centrally in the flow field 17. The channels of the flow field 17 shown run parallel to each other and parallel to an outer edge of the separator plate 2, i.e. in the x-direction in this example. In FIG. 5, a plurality of welded joints 50′ are arranged along at least some centrally located channels in the flow field 17 in the x-direction. In one example, several welded joints 50′ are arranged at a distance from one another along a straight line parallel to the y-axis, with the welded joints 50′ each extending essentially in the x-direction. In the example shown, the welded joints 50′ in a first channel are arranged offset from welded joints 50′ of a next channel in which welded joints 50′ are arranged. In other examples, the weld joints 50′ in a first channel may be at the same level as welded joints 50′ of a next channel in which welded joints 50′ are arranged. The latter is illustrated in FIG. 7, for example.

FIG. 7 schematically illustrates a section of a top view of a separator plate as shown in FIG. 6, where a row of welded joints 50′ is also arranged in the transition region 17′, which lies in the direction of flow between the distribution or collection region 20 and the flow field 17. In addition, the welded joints 50′ of FIG. 7, which are arranged in central channels of the flow field 17, are arranged in rows essentially at the same height (and not offset as in FIG. 6). In other embodiments, a first region of a flow field may have rows of parallel arrangements of welded joints 50′ as shown in FIG. 7 and a second region may have staggered weld seams as shown in FIG. 6.

In FIG. 7, welded joints 50′ are also arranged in the distribution region and/or collection region 20. In particular, the welded joints 50′ are arranged in the distribution or collection region 20 at an end of the channels of the distribution or collection region 20 facing the passage opening 11b. The welded joints 50′ of the distribution or collection region preferably extend in the main flow direction. The welded joints 50′ can have the same lengths or different lengths.

FIGS. 8A to 8C and 8D show various embodiments of a welded joint 50′ that can be used, for example, in a separator plate 2 as shown in the previous figures. The welded joint 50′ of FIG. 8A comprises a first weld seam 50, which was welded in a first direction, characterized by the direction of arrow I, starting at the first end 51 of the welded joint 50′ along a first imaginary straight line. The first weld seam 50 ends in a first end crater 53, which was only drawn in FIG. 8A for illustration purposes, but is no longer visible in the welded joint 50′. The length of the first weld seam 50 is illustrated by the length of the directional arrow I. The welded joint 50′ of FIG. 8A comprises a second weld seam 60, which was welded in a second direction, characterized by the direction of arrow II, starting at the second end 61 of the welded joint 50′ along the same first imaginary straight line. The second weld seam 60 overlaps the first weld seam 50 and was welded in such a way that it extends beyond the first end crater 53. The second weld seam ends in a second end crater 63. In FIG. 8A, the end crater 63 is arranged substantially centrally between the first end 51 and the second end 63 and is shown by means of substantially two ovals. The length of the second weld seam 60 is illustrated by the length of the directional arrow II. A width of the first weld seam 50 essentially corresponds to a width of the second weld seam 60 and a width of the welded joint 50′.

The welded joint 50′ of FIG. 8B comprises a first weld seam 50, which was welded in a first direction, characterized by the direction of arrow I, starting at the first end 51 of the welded joint 50′ along a first imaginary straight line. The first weld seam 50 ends in a first end crater 53, which was only drawn in FIG. 8B for illustration purposes, but is no longer visible in the welded joint 50′. The length of the first weld seam 50 is illustrated by the length of the directional arrow I. The welded joint 50′ of FIG. 8B comprises a second weld seam 60, which was welded in a second direction, characterized by the direction of arrow II, starting at the second end 61 of the welded joint 50′ along a second imaginary straight line. The first and second imaginary straight lines correspond to the center lines of the first and second weld seams 50, 60. The first and second imaginary straight lines run parallel to each other, but are at a distance from each other. The second weld seam 60 overlaps the first weld seam 50 and was welded in such a way that it extends beyond the first end crater 53. The second weld seam ends in a second end crater 63. The end crater 63 is also arranged substantially centrally between the first end 51 and the second end 61 in FIG. 8B. The length of the second weld seam 60 is illustrated by the length of the directional arrow II. A width of the first weld seam 50 essentially corresponds to a width of the second weld seam 60. The width of the welded joint 50′ varies. In an overlap region where the first weld seam 50 and the second weld seam 60 overlap, the welded joint has a maximum width.

The welded joint 50′ of FIG. 8C essentially corresponds to the welded joint of FIG. 8A, whereby the end crater 63 exactly overlaps the end crater 53 and is arranged closer to the first end 51 than to the second end 61. In the present case, the end crater 63 is approximately one end crater length away from the first end 51.

FIG. 8C′ schematically illustrates a height profile along the section B-B indicated in FIG. 8C through the welded joint 50′ and the end crater 63 of FIG. 8C. The graph K shows a height profile of the weld seam over a section of its length in the region of the end crater 63. The double arrow illustrates the length of the end crater 63. In the region outside the end crater 63, the surface of the weld seam is noisy, while the surface in the end crater 63 is smoother.

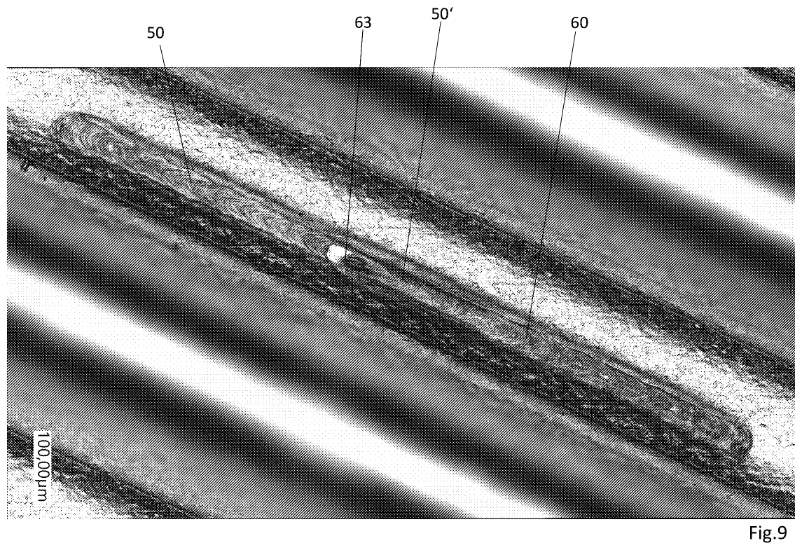

FIG. 9 shows a section of a top view of an individual plate of the separator plate 2 according to one of the previous figures with an end crater 63, looking from a beam entry side, i.e. on plate 2b. The welded joint 50′ shown corresponds to the welded joint in FIG. 8A. The first weld seam 50 has first imbricated weld solidification lines in a region that is not overlapped by the second weld seam 60, while the second weld seam 60 has second imbricated weld solidification lines that run in the opposite direction to the first imbricated weld solidification lines.

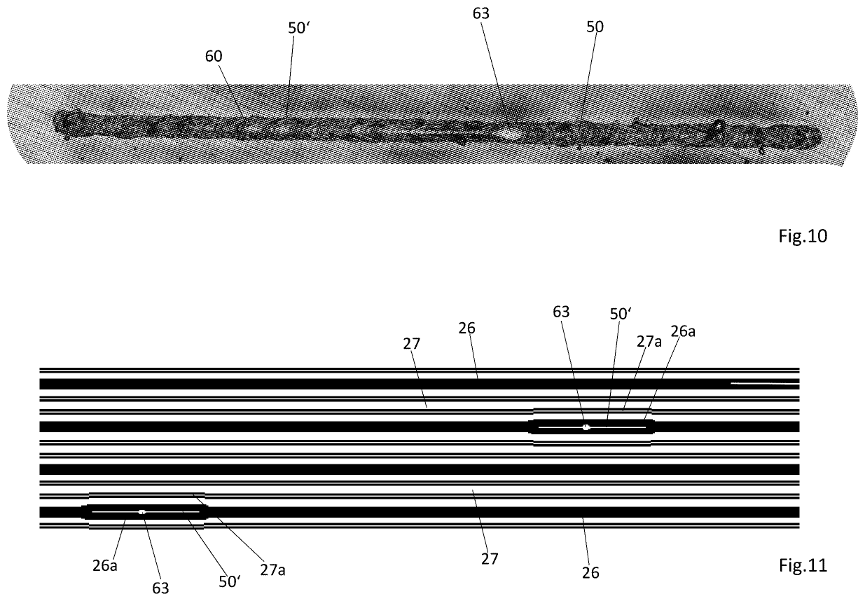

FIG. 10 shows a section of a top view of an individual plate of the separator plate 2 according to one of the previous figures, looking from a beam exit side, i.e. to the rear side of the plate 2a. The welded joint 50′ shown corresponds to the welded joint in FIG. 8A.

FIG. 11 shows a schematized section of a top view of a separator plate 2, in which the channels 26 in the regions in which the welded joints 50′ are provided are designed as wider channel sections 26a and with steeper channel walls or the webs 27 with steeper web walls 27a. This results in an enlarged contact surface of the two individual plates 2a, 2b, so that even in the event of a slight offset of the laser beam, it is ensured that the welded joint 50′ is realized in a region in which the two individual plates 2a, 2b lie on top of each other with essentially no gap. The end craters 63 are each not terminal here either.

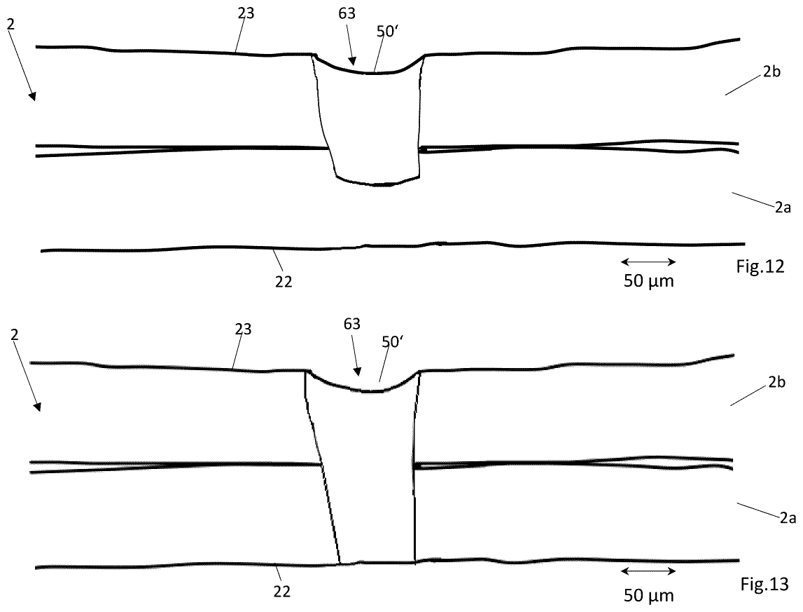

FIGS. 12 and 13 each show a schematic section through the separator plate 2 in the region of an exemplary welded joint 50′. The cuts are essentially perpendicular to the direction of the welded joint 50′. While FIG. 12 shows a region in which the welded joint 50′ extends through the entire material thickness of the second plate 2b, but only through approximately one third of the material thickness of the first plate 2a, the weld seam 50′ in FIG. 13 is shown in a region that extends completely through the material thickness of the second and first plates 2b, 2a. The welded joint 50′ thus extends here from the outer side 22 of the first plate 2a to the outer side 23 of the second plate 2b. As shown in FIG. 12, the welded joint can also only be visible on one of the two outer sides 22, 23—the beam entry side—and not extend all the way to the respective other outer side 23, 22. As indicated in FIGS. 12 and 13, the first individual plate 2a and/or the second individual plate 2b can have a thickness of at least 50 μm, in particular at least 70 μm. The thickness of the plates may also be at most 200 μm, in particular at most 150 μm, in particular at most 100 μm. Given these relatively small thicknesses, it may be that the welded joint 50′, as shown in FIG. 13, is in the form of a through-weld.

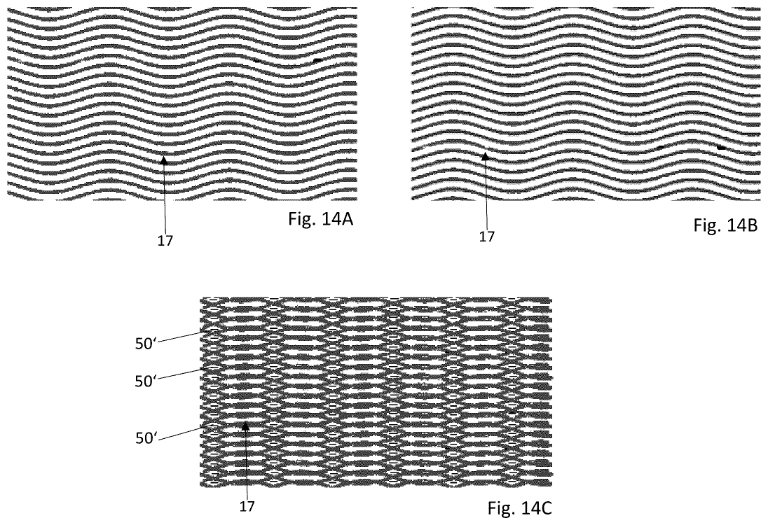

FIGS. 14A-B each schematically show a section of a top view of a flow field 17 of an individual plate with different channel shapes. FIG. 14A, for example, shows a top view of a section of a flow field of an individual plate 2a, while FIG. 14B shows a section of the flow field 17 of the associated individual plate 2b in a top view. A plurality of wavy webs with a wavy shape in plan view, such as a sine wave or zigzag shape, define channels for media guidance between the wavy webs. FIG. 14C shows a view that results when both individual plates 2a, 2b are made to overlap in the region of their flow fields 17. This results in a large number of transfer points for the fluid, in particular coolant, between the two individual plates 2a, 2b. Welded joints 50′ as described above can also be formed in flow fields shaped in this way; for the sake of clarity, only some of these are marked with reference numbers.

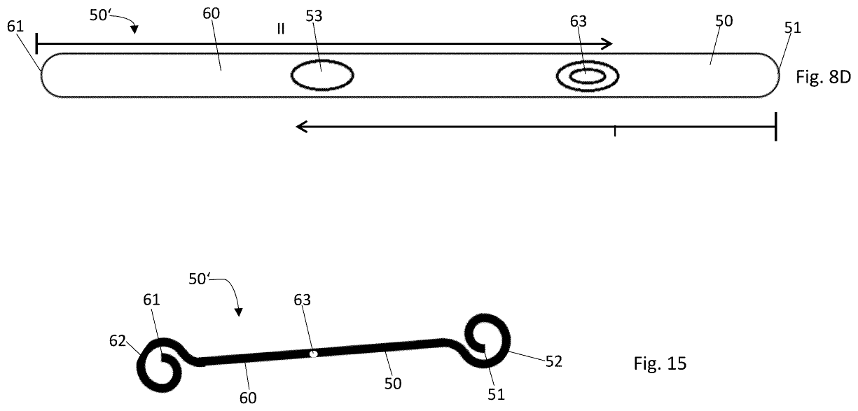

FIG. 15 is a schematic top view of a further embodiment of a welded joint 50′ according to the present disclosure with a first weld seam 50 and a second weld seam 60 overlapping the first weld seam in sections. Unlike in the previous examples, the first and second ends of the welded joint 51, 62 are not located in a straight section of the welded joint 50′ but in a curved end region. Again, the end crater 63 of the second weld seam and the welded joint is located away from the first and second end regions 52, 62 of the welded joint 50′. Both the first and the second end of the welded joint 51, 62 thus do not form the outermost end of the welded joint 50′, which makes the welded joint 50′ more robust against pulsating fluid, but requires more space. A combination of the channel expansions 26a shown in FIG. 11 with the embodiment of the welded joints 50′ shown in FIG. 15 can therefore be advantageous.

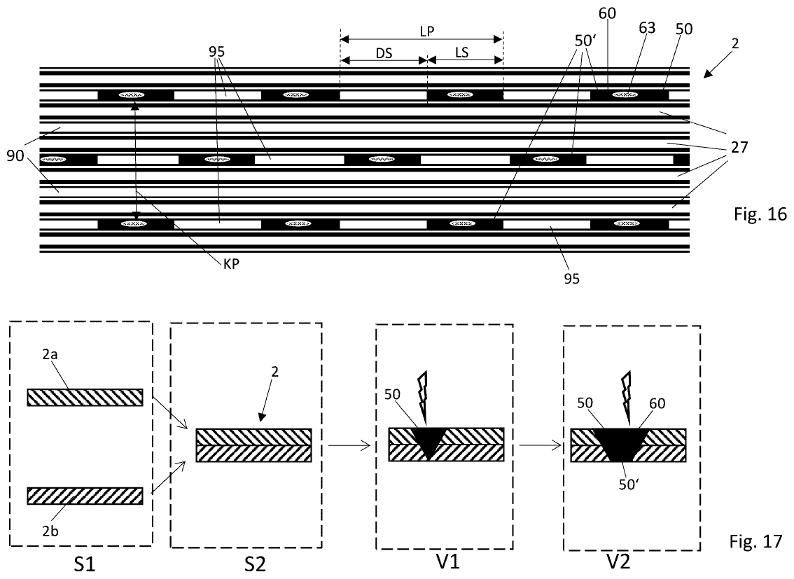

FIG. 16 shows schematically a top-view onto a section of an active area of a further exemplary separator plate. The welded joints 50′ here show a length LS, e.g. 0.6 mm, which is essentially identical to the distance DS between one end of a welded joint 50′ and the beginning of the closest welded joint 50′ within the same channel 95 in the section depicted. There is one channel 90 without welded joints and two webs 27 arranged between two welded joints 50′ closest to each other in a direction transverse, thus under an angle of more than 0° but less than 90°, to the main extension direction of the channels 90, 95. If one considers the welded joints 50′, which are situated closest to one another on a line orthogonal to the main extension direction of the channels 90, 95, then there are three channels and four webs 27 arranged between these welded joints 50′ in the section considered, two of these channels are channels 90 without welded joints and one of these channels, channel 95, comprises welded joints.

FIG. 17 finally schematically shows a method for the production of a separator plate 2. In a first step S1, a first individual plate 2a and a second individual plate 2b are provided. Each of them comprises at least one through-opening for the passage of a fluid, a flow field, and a transition region which is arranged between the flow field and the through-opening. The transition region fluidically connects the through-opening and the flow field to one another. In a further, second, step S2, the two individual plates 2a, 2b are placed one on the other, so that a contact zone is formed. In a first jointing step V1, both individual plates 2a, 2b are joined to each other in the contact zone of the individual plates by means of a first weld seam 50 which extends orthogonal to the plane of the figure. In a second jointing step V2, both individual plates 2a, 2b are joined to each other in the contact zone of the individual plates by means of a second weld seam 60 which extends orthogonal to the plane of the figure. The two weld seams 50, 60 overlap with one another in sections and together form a welded joint 50′ extending longitudinally from a first end located in a first end region of the welded joint 50′ to a second end located in a second end region of the welded joint 50′. This welded joint forms an end crater between the first end and the second end and the end crater is spaced from the first end and from the second end.

The invention claimed is:

1. A separator plate for an electrochemical system, comprising a first individual plate and a second individual plate connected to the first individual plate by means of a welded joint,
each individual plate comprising at least one through-opening or passage of a fluid, a flow field, a distribution or collecting region which fluidically connects the at least one through-opening to the flow field, and a transition region which is arranged between the flow field and the distribution or collecting region,
wherein the welded joint is arranged in the flow field and/or in the transition region,
wherein the welded joint extends longitudinally from a first end located in a first end region to a second end located in a second end region, wherein the welded joint forms an end crater between the first end and the second end and the end crater is spaced from the first end and from the second end.

2. The separator plate according to claim 1, wherein the end crater is located in a central 85% between the first end and the second end of the welded joint.

3. The separator plate according to claim 1, wherein the welded joint comprises a first weld seam extending from the first end of the welded joint towards the second end of the welded joint, encompassing the end crater and beyond the end crater, and the welded joint comprises a second weld seam which extends from the second end of the welded joint towards the first end of the welded joint encompassing the end crater, to an end of the end crater facing the first end of the welded joint.

4. The separator plate according to claim 3, wherein the end crater has a distance to the first end and/or to the second end of the welded joint of at least 20%, and/or of at most 1000% of a width of the first weld seam and/or second weld seam.

5. The separator plate according to claim 3, wherein the end crater has a length which corresponds to at least 25% and/or at most 600% of a width of the first weld seam and/or second weld seam.

6. The separator plate according to claim 3, wherein the first weld seam has imbricated weld solidification lines in a first direction at least in sections and the second weld seam has imbricated weld solidification lines in a second direction at least in sections, wherein the second direction is opposite to the first direction.

7. The separator plate according to claim 1, wherein an overlap region has a length—which corresponds to at least 400% of the length of the end crater and/or
corresponding to at most 80% or at most 60% or at most 50% or at most 40% or at most 35% of the length of the welded joint and/or
corresponding to at least 10% of the length of the welded joint or at least 20% of the length of the welded joint or at least 30% of the length of the welded joint.

8. The separator plate according to claim 1, wherein the welded joint has a shape which is designed such that it can be formed by applying a welding tool and/or welding laser beam at most one time.

9. The separator plate according to claim 1, wherein the first individual plate has, in a front side facing away from the second individual plate, structures in the flow field for guiding a reaction medium along the front side of the first individual plate, and wherein the second individual plate has, in a rear side facing away from the first individual plate, structures for guiding a reaction medium along the rear side of the second individual plate and wherein the structures for guiding a reaction medium in cases are formed by a plurality of webs and channels extending between the plurality of webs and delimited by the plurality of webs.

10. The separator plate according to claim 9, wherein a plurality of welded joints (50′) are arranged at a bottom of the channels.

11. The separator plate according to claim 9, wherein the channel of at least one individual plate is widened in a region of a welded joint.

12. The separator plate according to claim 9, wherein the plurality of webs and channels in the flow field are rectilinear and run parallel to one another.

13. The separator plate according to claim 9, wherein the plurality of webs and channels in the flow field are wave-shaped and in particular run next to one another with substantially the same wave shape and/or are periodically repeatingly trapezoidal and in particular run next to one another with substantially the same trapezoidal shape.

14. The separator plate according to claim 1, wherein in each case at least one welded joint is arranged in a plurality of channels in the flow field, wherein at least in sections, orthogonal to or transverse to a main extension direction of a channel, at the most four channels are arranged between two welding joints being closest to each other.

15. The separator plate according to claim 1, wherein a plurality of spaced-apart welded joints are arranged along a channel, wherein at least in areas within one channel, a length of the welding joints and/or a distance between the welding joints closest to each other within one channel is between 0.2 mm and 3 mm.

16. A method for producing a separator plate, comprising:
I. providing a first individual plate and a second individual plate, each individual plate comprising at least one through-opening for passage of a fluid, a flow field, and a transition region which is arranged between the flow field and the at least one through-opening and fluidically connects the at least one through-opening and the flow field to one an-other and
II. connecting the first and second individual plates by means of a welded joint in a contact zone of the individual plates, the welded joint being designed such that the welded joint extends longitudinally from a first end located in a first end region to a second end located in a second end region and the welded joint forms an end crater between the first end and the second end and the end crater is spaced from the first end and from the second end.

17. An electrochemical system comprising a plurality of stacked separator plates according to claim 1.

18. The electrochemical system according to claim 17, wherein a membrane electrode assembly comprising a membrane and an edge portion surrounding the membrane at least in sections is arranged between each pair of adjacent separator plates of the plurality of stacked separator plates.

19. The electrochemical system according to claim 18, wherein the flow field is located within the edge portion.

20. The electrochemical system according to claim 19, wherein the membrane of the membrane electrode assembly extends in each case at least over the flow field of the adjacent separator plates.
